(19) United States
(12) Patent Application Publication
(10) Pub. No.: US 2015/0213406 A1
(43) Pub. Date: Jul. 30, 2015

(54) METHOD AND SYSTEM FOR AGGREGATING AUCTION RESULTS AND CREATING CUSTOMIZABLE REPORTS

(71) Applicant: DVAuction, Inc., Norfolk, NE (US)

(72) Inventors: Dustin W. Markham, Kansas City, KS (US); Alan M. Morehead, Lincoln, NE (US); Daniel R. Broz, Norfolk, NE (US)

(21) Appl. No.: 14/610,723

(22) Filed: Jan. 30, 2015

Related U.S. Application Data
(60) Provisional application No. 61/933,656, filed on Jan. 30, 2014.

(51) Int. Cl. G06Q 10/10

(52) U.S. Cl. CPC G06Q 10/10

(57) ABSTRACT

A method and system for aggregating data from auction sales, formatting the data, storing the data, and creating customized reports and alerts is provided. The system can include a server that collects data from auction sites, a server that formats the collected data, a database that stores the data, and a server linking a platform interface to the database. The method and system may also include a report module that receives user inputs and generates a custom report containing data from the database that conforms to the user-selected inputs. The user may access the report module by connecting to a network server and accessing the platform interface. The method and system may also include an alert module that receives user inputs and searches the database for data that meets the user inputs. The system may then generate and send the user a email or text if triggering data is found.

### CROSS-REFERENCE TO RELATED APPLICATIONS

This Application claims priority to U.S. Provisional Patent Application Ser. No. 61/933,656, filed on Jan. 30, 2014, to Dustin W. Markham et al., entitled “Method and System for Aggregating Auction Results and Creating Customizable Reports,” currently pending, the entire disclosure of which is incorporated herein by reference.

### BACKGROUND

Auction sites, such as livestock sale barns, automobile auctions, and equipment auctions receive vast amounts of data and information related to the individual sales occurring at each auction. This information can be extremely beneficial to buyers, sellers, speculators, analysts and the like that follow the auctions and the markets of the goods and services sold at the auction sites. For example, livestock sale barns create vast amounts of sales transactions for cattle and other livestock almost every day. In addition, the sale prices of cattle and other livestock vary from auction site to auction site, especially when the compared auction sites are in different states or regions. This is typically due to the fact that information and data relating to the sales cannot be communicated to buyers, sellers, speculators and analysts from auction site to auction site quickly enough. Typically, when data is collected from auction sites, it is provided to a central location only at extended time intervals and only by a minority of auction sites. As a result, the information and data about the market of the particular goods or services is often outdated and inaccurate. Additionally, once buyers, sellers, speculators and analysts acquire the information, it is not sufficiently processed or formatted and is too vast and expansive to be beneficial.

Accordingly, a need exists for a method and system allowing sales data from multiple auction sites to be aggregated, formatted and displayed to interested users for various goods and services. A need also exists for a method and system that can customize the data based on specific user needs and generate automatic alerts when certain conditions occur at various auction sites.

### SUMMARY OF THE INVENTION

One objective of the present invention is to provide a method and system for acquiring data and information for individual sales occurring at auction sites (i.e., auction results data), formatting this auction results data and storing the data in a central database accessible through an online platform interface. The auction sites may include both brick-and-mortar and online or remote auction sites. A further object of the present invention is to collect and aggregate this information on almost a real-time basis such that the most current and up-to-date data is accessible through the platform interface. Yet a further object of the present invention is to provide a method and system capable of providing a user with customized reports containing data related to auction sales that meet only the specific requirements selected by a user in order to allow the user to compare, analyze and track particular components and categories. Yet a further object of the present invention is to provide a method and system capable of allowing a user to select specific parameter thresholds that, if identified within the central database, trigger an alert that is generated and sent directly to the user.

In one embodiment of the present invention, a method and system is provided that includes a computer network system that may collect auction results data from multiple auction sites. The system may then analyze and format the auction results data through one or more servers. Once analyzed and formatted, the system may then add the auction results data to an information database. This data collection process can occur continuously, nearly continuously, or at specific time intervals. The system may also include a server and platform that allows users to access the auction results data located in the information database in several advantageous forms.

In one embodiment of the present invention, the method and system also includes a report generating module. The reports generated by a user of the platform can be standardized reports with pre-selected parameters or customized reports based on various parameters input by the user. The customized reports may allow users to select specific parameters and receive customized reports based on those parameters. The system may receive one or more user-selected parameter criteria from a user that is connected to the system though a server and the platform interface. Once the user provides the parameter criteria, the system may then search the information database via a network server and identify all auction results data in the information database that satisfies the user-selected parameter criteria. The system may then use a report generator to create a customized report and display the report to the user. The parameter criteria selected by the user may include any number of specific information types depending on the type of goods and services involved. If desired, the reports may also be automatically generated on a specified frequency (e.g., daily, weekly, monthly, etc.).

In another embodiment of the present invention, the method and system may also provide a user with alerts via email or SMS text, for example, when defined parameter criteria are met (e.g., 700-800 lbs, steers, black, sold at <$200 cwt). The system may receive one or more user-selected parameter thresholds for a customized alert. Upon receiving the one or more parameter thresholds, the system may search the information database for auction results data triggering the parameter threshold(s). This search may be facilitated through a network server. The system may continue to perform a search of the information database at any desired time interval until triggering auction results data is identified. Upon identifying triggering auction results data, the system may generate an alert through an alert generator that notifies the user of the triggering auction results data. The system may then transmit or send the generated alert through an alert message gateway, such as email or SMS text.

The reports and alerts may allow a user to access, sort, track and chart sale results, thereby enabling the user to analyze current, future and past auction market trends. As such, when used in connection with livestock, the reports can provide critical live market price information to order buyers, feedlot owners and managers, commodity brokers and traders, risk managers, economists and livestock market producers. When used in connection with other types of goods and services, the reports and alerts can provide critical sale information to automobile buyers, car lot owners, equipment dealers, real estate brokers and other individuals with an interest in tracking the sale of certain goods and services.

Other aspects and advantages of the present invention will be apparent from the following detailed description of the preferred embodiments and the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a flow chart illustrating a method of aggregating auction results data and creating customized reports and alerts in accordance with one embodiment of the present invention;

FIG. 2 is a block diagram illustrating a network-based computer system for aggregating auction results data and creating customized reports and alerts in accordance with one embodiment of the present invention;

FIG. 3 is a page view of a graphical user interface for creating a custom report within the system including input fields for setting parameters upon which customized alerts are created in accordance with one embodiment of the present invention;

FIG. 4 is a page view of a graphical user interface for displaying a created custom report within the system in accordance with one embodiment of the present invention;

FIG. 5 is a page view of a graphical user interface for creating a custom alert within the system including input fields for setting parameters upon which customized alerts are created in accordance with one embodiment of the present invention; and

FIG. 6 is a page view of a graphical user interface for displaying an alert generated by the system in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

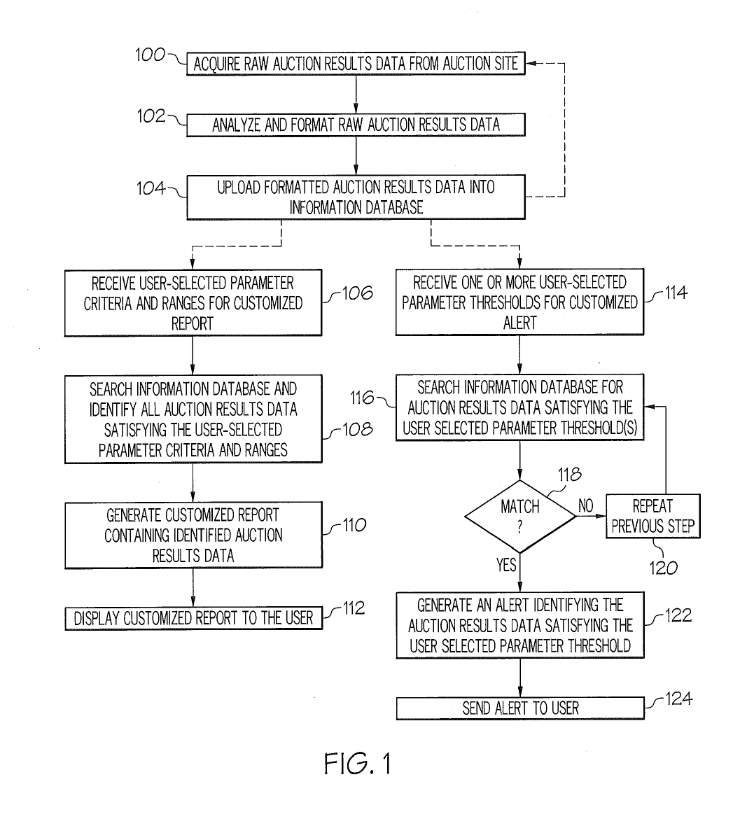

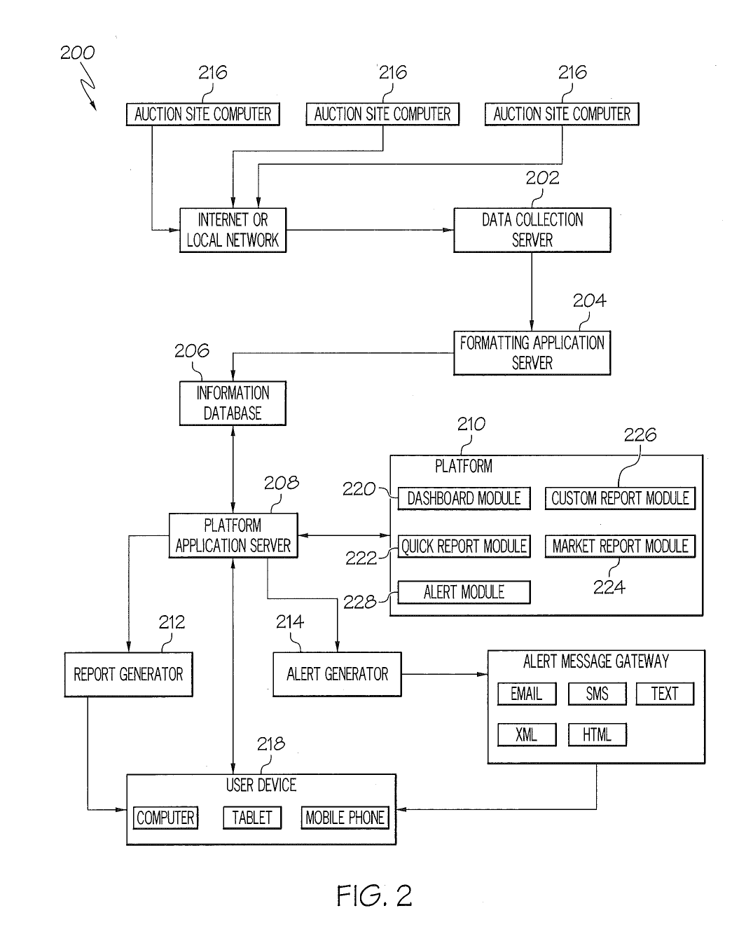

One embodiment of the present invention is directed generally to a method and system, as illustrated in FIGS. 1 and 2, for acquiring auction results data from auction sites, analyzing and formatting the auction results data, aggregating and storing the auction results data into a database, and using the auction results data to generate customized reports and alerts. The system 200, described in greater detail below, may be a computer network including one or more servers, one or more databases, and a platform interface 210. According to one embodiment of the present invention, the system includes a data collection server 202, a formatting application server 204, an information storage database 206, a platform application server 208, and the platform interface 210, as shown in FIG. 2. The system 200 may be connected to, and in communication with, the individual auction sites and platform users through the interne or local network. The platform interface 210, described in greater detail below, may allow authorized users to access the aggregated and formatted auction results data in one or more forms, including standardized and customized reports. The method and system may also utilize the platform interface 210 to allow users to create customized alerts and generate and send those alerts to the user in various forms.

The auction results data generally pertains to results of sales occurring at one or more auction sites, including brick-and-mortar sites and online or remote sites. For example, when a sale at an auction site occurs, info nation about the sale or lot of goods or services sold may be collected. This information may be included in the auction results data for that particular sale or lot. The auction results data may also include information related to each sale occurring at the one or more auction sites. The method and system of the present invention may be used in connection with traditional auctions, but may also be used in connection other formats of sales, including fixed price sales, reverse auction sales, formats of sales now known or hereafter developed and combinations thereof. The auction results data may include, for a sale occurring at an auction site, the sale price, sale date, sale location, and specific criteria of the sale depending on the type of auction or sale. For example, in one embodiment of the present invention, the auction type or sales relate to cattle auctions or sale barns. In such an embodiment, the specific criteria may include, but is not limited to, sex and type (e.g., steers, heifers, bulls, cows, calves, dairy cows, bred cows, etc.), weight, age, head count, and hair color. As a non-limiting example, according to one embodiment where the auction sale includes the sale of cattle, the auction sales data for that sale may include: the type of cattle (e.g., steers), the head count (e.g., 5), total weight (e.g., 3000 lbs.), average weight (e.g., 600 lbs.), sale price (e.g., $215.00 cwt), sale location (e.g., Vienna, Mo.), and sale date (Jan. 21, 2015). The foregoing list is merely an example of a list of possible auction results data and is not intended to limit the type of auction results data used in the method and system of the present invention.

In another embodiment of the present invention, the auctions and sales relate to automobile auctions. In such an embodiment, the specific criteria may include, but is not limited to, year, make, model, mileage, style, condition, color, trim package, engine size, transmission, drive train, number of doors, and interior features. The present invention may also be used in connection with other livestock, genetic materials (e.g., embryos and semen), construction equipment, agricultural equipment, industrial equipment, consumer items, real estate, farm and ranch land, residential properties, commercial properties, commodities and any other goods or services that may be bought or sold. When the method and system of the present invention are used in connection with construction or agricultural equipment, the specific criteria may include, but is not limited to, year, make, mode, horsepower, drive type, size, dimensions, and number of engine hours. The specific criteria may also include several types or categories of information relating to the sale that would be appreciated by one of skill in the art.

The auction results data may also include visual data components, such as video clips or photographs. For example, when the present invention is used in connection with cattle or other livestock, a short video clip of the animal(s) at the auction site or sale barn may be included in the auction results data. In another embodiment, when the present invention is used in connection with automobiles, photographs of the automobile may be included in the auction results data.

As shown in FIG. 1, the method of the present invention, according to one embodiment, may begin with acquiring raw auction results data from one or more auction sites. In one embodiment, each auction site inputs, sends or uploads the auction results data to the data collection server 202 through an auction site computer 216 via the interne, local network, or similar means. In another embodiment, the system 200 acquires, mines, or scrapes the auction results data from each auction site through the auction site computer 216 containing the data. This may be accomplished through data collection consoles or operators within the system 200.

New auction results data may be uploaded into the system 200 at any specified time interval, continually, or on nearly a continual real-time basis. In one embodiment, the auction results data is collected and sent to the data collection server 202 every 2-4 seconds. In another embodiment, every 2-4 minutes. In another embodiment, every hour. Any specified interval of time may be used. Alternatively, the auction sites may upload the auction results data after a sale at the auction site occurs, according to one embodiment of the present invention.

Once the data collection server 202 receives the auction results data, the server may determine whether the auction results data contains new information, updates of existing information, or previously acquired information. The data collection server 202 may then send the new and updating information to a formatting application server 204 that may format the auction results data. In an alternative embodiment, a single server may perform the operations of both the data collection server 202 and the formatting application server 204. The formatting application server 204 may separate the auction results data into clusters for each individual lot or sale occurring at an auction site. The formatting application server 204 may also format each cluster with common fields, such as sale date, sale location, sale price, etc. The formatting application server 204 may also create custom fields for auction results data not formatted into a common field. The clusters of auction results data related to the individual lots or sales may then be tagged, or otherwise identified, based on a generalized category, such as but not limited to, auction type, auction location, or auction date. Tagging or otherwise placing an identifier on each component of auction results data may allow that data component to be identified or located during a search of the system database. Once the auction results data is formatted, it may then be sent to an information database 206 where it is aggregated and stored along with previously formatted auction results data. The information database 206 may comprise one or more databases. As shown in FIG. 2, the information database 206 may be linked to a platform application server 208 to allow the auction results data to be accessible through the platform interface 210.

The data collection server 202 and formatting application server 204 may analyze and format the auction results data at any specified time interval. In one embodiment, the data collection server 202 and formatting application server 204 analyze and format the auction results data each time new auction results data is received by the data collection server. In another embodiment, the data collection server 202 may temporarily store collected auction results data for a specified time interval before the data collection server 202 and formatting application server 204 analyze and format the collected auction results data.

The following is a non-limiting example of the data collection component of the system and method of the present invention, according to one embodiment. The following is intended only to describe one possible embodiment of the present invention and is not intended to limit or restrict the method and system of the present invention in any manner. When collecting data from the various auction sites, operator consoles may collect information every 2-4 seconds. The operator consoles run in an Adobe® Flash Media Player environment inside of a web browser (or other suitable software). Operators of the various auction sites can log into a specific event, where configuration information for a sale information's source is retrieved based on their domain. The location of this data source can be local to the operator's computer, a device on the local network, or an accessible device on the interne, depending on the system utilized by the individual auction site. The data source file that is used to retrieve the data is in XML format with common fields for Category, Total Weight, Head Count, and Consignor, among others. Additional custom fields and values are passed in, if present, where it will be logged and displayed. The data is then sent to an Adobe® Flash Media Server using the real-time RTMP protocol (or other suitable software) to update information related to that auction's instance. At this time, the information can be stored in a real-time shared dataset with all users of the platform 210. A data collection script is run to determine if the information should be logged to permanent storage. The media server then determines if the data is new sale information or an update to the current sale information. The media server sends the information to an application server 204, which parses out all the data fields and stores them as base sale information and dynamic sale properties. The application server 204 then assign's the information a generalized category, reformats it to a standard convention, and then stores the information permanently.

The auction results data may be formatted and stored in the information database 206 through several different methods known to those having skill in the art. The auction results data for each sale may be tagged based on sale date or location or other suitable criteria. Alternatively, the auction results data for each sale may receive a data ID. Several other methods may also be used. In one specific embodiment, the auction results data for each sale is logged to two database tables—i.e., a “Sales” table to store data for each sale and a “Properties” table to store dynamic data about the sale (e.g., type, weight, head count, location, etc. for cattle or year, make, model, mileage, etc. for automobiles). Additional tables could also be used to manage access and information about the event/location the sale is under. Each sale can be assigned to an “Events” table, so that information about the location of the sale and possible consignors may be accessed. The dynamic sale properties tables can have generic “field” and “value” columns that allow virtually unlimited options for information related to the sale. The foregoing is merely a non-limiting example of the possible organizational structure of the information database 206.

Once the auction results data is stored in the information database 206, it may be accessible by the platform server 208 that may operate the platform interface 210 and may generate reports and alerts, as shown in FIG. 2.

The platform interface 210 may allow users of the platform 210 to access the auction results data in several different ways. As shown in FIG. 2, the platform 210 may include a dashboard module 220, quick report module 222, market report module 224, custom report module 226, and alert module 228. The platform 210 and each of the modules may be accessed by platform users through the internet, or local network, and the platform application server 208. Each module may be displayed in the form of a graphical user interface accessible within the platform 210. The dashboard, quick report, and market modules 220, 222, and 224, respectively, may generate standardized reports from the auction data results stored in the information database 206. For example, when the method and system of the present invention are used in connection with cattle sales in accordance to one embodiment, the dashboard module 220 may display a cumulative average price of cattle for various parameters (e.g., 600-699 lbs. steers) that is updated on a real-time, or almost a real-time, basis. In accordance with the same embodiment, the quick report and market report modules 222 and 224, respectively, may display a graphical user interface that enables the user to select from pre-determined parameter to generate a report. Other modules and reports types may be provided within the platform 210 as well.

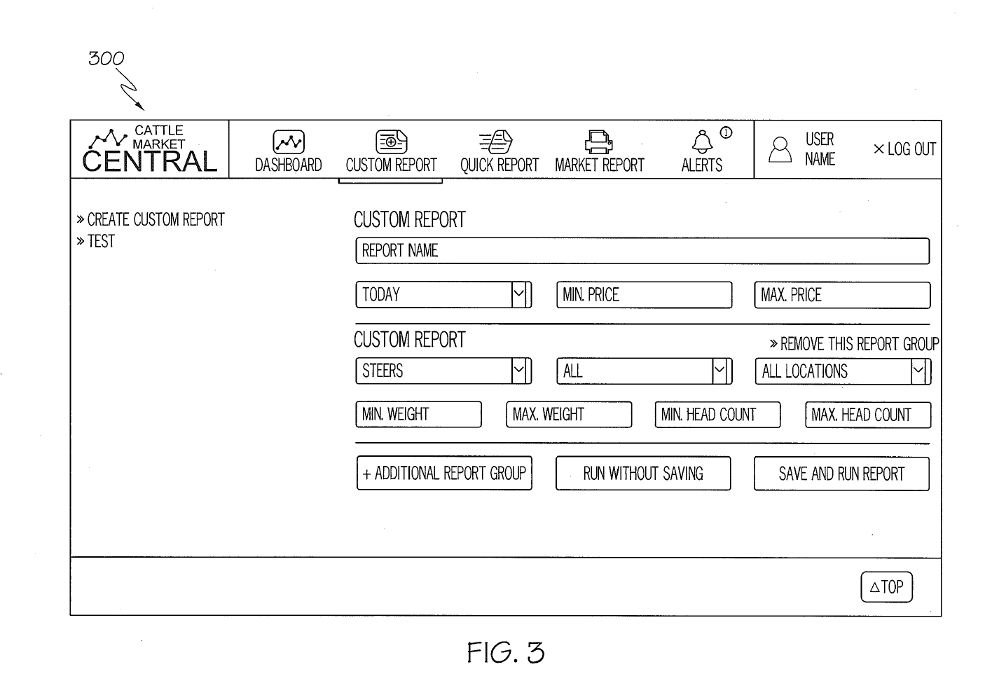

The method and system of the present invention may also include a custom report module 226, which may be accessible through the platform 210. As shown in FIG. 1, the custom report module 226 may allow users to select specific parameter criteria and ranges to be used in creating a customized report 302. The custom report module 226 may then generate a customized report 302 containing auction results data from the information database 206 that satisfies specific parameter criteria and ranges selected by a user. In particular, the customized report 302 may include auction results data from one or more auction sites, allowing a user to compare, examine or analyze sales occurring at different auction sites. The custom report module 226 may then format and display the customized report 302 to the user through the platform interface 210. As best shown in FIG. 2, a user may access the platform 210, and the custom report module 226, by accessing the platform application server 208 through a user device 218, such as a computer, tablet, mobile phone, or other suitable device. From the home-page graphical interface of the platform 210, a user may select the custom report module 226. The platform 210 may then display the custom report module graphical interface 300, as shown in FIG. 3, according to one embodiment of the present invention.

The custom report graphical interface 300 may allow a user to select several different parameters and ranges to a specific report. Any or all of the criteria (sale price, sale date, sale location, and specific criteria) contained in the auction results data may be used as parameters to refine and customize an individual report 302. As shown in FIG. 3, according to one embodiment of the present invention, the interface 300 may include a drop-down menu that allows the user to enter a specific date range parameter. This drop-down menu may allow the user to select from a standardized range, such as Today, 24 hours, 48 hours, 72 hours, 7 days, 14 days, and 30 days. The drop-down menu may also allow the user to select a custom date range and provide fields for the user to enter specific dates. In another embodiment, when the custom date range is selected, the interface may provide a calendar display to assist the user in selecting the date range. According to one embodiment of the present invention, the custom report module 226 may also allow a user to enter minimum and/or maximum price parameters. For example, when used in connection with cattle sales, the user may enter a minimum price of $200 cwt, meaning that the report will only include auction results data from sales where cattle sold for $200 cwt (per hundred-weight) or more.

The custom report module 226 may also allow the user to select (or enter) a specific category or subset of the lot or sales relating to the auction results data, according to one embodiment of the present invention. As shown in FIG. 3, when the method and system is used in connection with cattle sales, the interface 300 and module 226 may allow the user to select from a particular category of cattle, such as steers, heifers, bulls, cows, baby calves, fats, dairy cows, bred cows, pairs, etc. The custom report interface 302 may also allow the user to select (or enter) a specific sale location as a parameter, as shown in FIG. 3, according to one embodiment of the present invention. The sale location parameter may provide several options of geographic areas to select from. For example, the user may be able to select from a particular state (e.g., KS, MO, KY, or NE), a particular region (e.g., north central, south central, or southeast), or a specific auction site.

Many other parameters may be used in the customized report module 226, depending on the particular goods or services sales utilized with the method and system of the present invention. As shown in FIG. 3, when the method and system of the present invention are used in connection with cattle sales, the custom report interface 300 may allow the user to select specific parameter ranges for weight and head count. In addition, several other criteria included in the auction results data may be included as optional parameters, such as but not limited to hair color for cattle.

When the method and system of the present invention are used in connection with other goods/services sold at auction sites, the custom report module 226 and graphical user interface 300 within the platform 210 may utilize parameters and ranges different from those shown in FIG. 3. For example, when the method and system of the present invention are used in connection with automobiles, according to one embodiment of the present invention, the user may be able to select a specific type (e.g., car, truck, SUV, etc.), a specific brand (e.g., Ford, Dodge, Honda, Toyota, Nissan, etc.), specific year or years, along with many other parameters.

The custom report module 226 and interface 300 may also allow the user to include and compare multiple Report Groups within a single report as shown in FIG. 3, according to one embodiment of the present invention. According to one embodiment of the present invention when the method and system are used in connection with cattle sales, as shown in FIG. 3, the custom report module 226 and interface 300 may allow the user to create a first Report Group that includes a first type (e.g., steers, heifers, etc.), a first sale location (e.g., NE, KY, MO, etc.), a first weight range (e.g., 600-699 lbs.), and a first head count range (e.g., 1-15). The user may then select to add a second Report Group that includes a second type, a second sale location, a second weight range, and a second head count range. Additionally, the user may select to add any number of additional Report Groups.

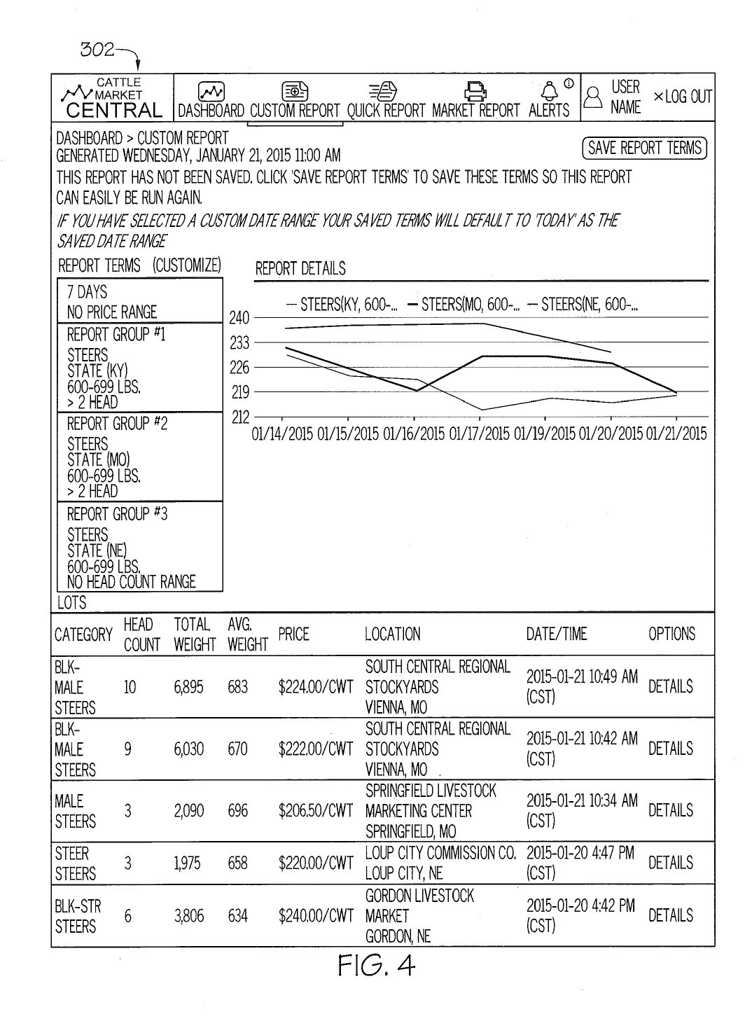

Once a user selects and/or enters the specific parameter criteria and ranges for a customized report, the platform application server 208 may then search the information database 206 and retrieve all auction results data satisfying the specific parameter criteria and ranges. As shown in FIG. 1, the platform application server 208 may then send the identified auction results data to a report generator 212 that may generate a customized report 302 containing only auction results data satisfying the user-selected parameter criteria and ranges. The platform application server 208 may then use the platform interface 210 to display the customized report 302 to the user. As shown in FIG. 4, the customized report 302 may include a Report Terms that provides a summary of the parameter criteria and ranges selected by the user, including the one or more Report Groups selected. The customized report 302 may also include a chart or other graphical feature that may summarize the auction results data included in the customized report. The customized report 302 may also include a Lots (or sales) display that provides specific information from the auction results data for each sale from an auction site that was identified in the report. The Lots display may include the sale price, sale date, sale location, and other specific criteria depending on the type of goods/services. Additionally, the Lots display may include a Details component that provides a graphical feature such as a video or photograph that was included with the auction results data for that particular sale or lot.

A non-limiting example of a generated customized report 302, according to one embodiment of the present invention, is shown in FIG. 4. The particular embodiment shown in FIG. 4 uses the method and system of the present invention in connection with cattle sales. As shown in FIG. 4, the Report Terms display shows the parameter criteria and ranges selected by the user. The Report Details display provides a graphical chart of the auction results data for each Report Group selected by the user. In the particular embodiment shown in FIG. 4, the graphical chart uses sale price and sale date to create a line graph showing the price fluctuations for each Report Group selected by the user. Other parameter criteria may also be used to formulate the graphical chart, such as but not limited to sale price and sale location in alternative embodiments. The embodiment shown in FIG. 4 also includes a Lots display, showing the auction results data associated with each lot or sale satisfying the parameter criteria and/or ranges selected by the user and identified in the information database. As shown in FIG. 4, the Lots display includes information from the auction results data for each lot or sale separated into specific categories, including category type, head count, total weight, average weight, price, location, date and options. In one embodiment of the present invention, the “options” category provides a link to a video clip or photograph included in the auction results data as explained above.

The customized reports 302 may allow a user to access, sort, track, and chart sale results from one or more auction sites by accessing the information database through the platform 210 and platform application server, thereby enabling the user to analyze current, future and past market trends for particular goods and services sold at auction sites. The system 200 of the present invention may also allow users to gain access to up-to-date or current information through customized reports 302 when the data collection server 202, formatting application server 204, and information database 206 operate at a high frequency interval rate.

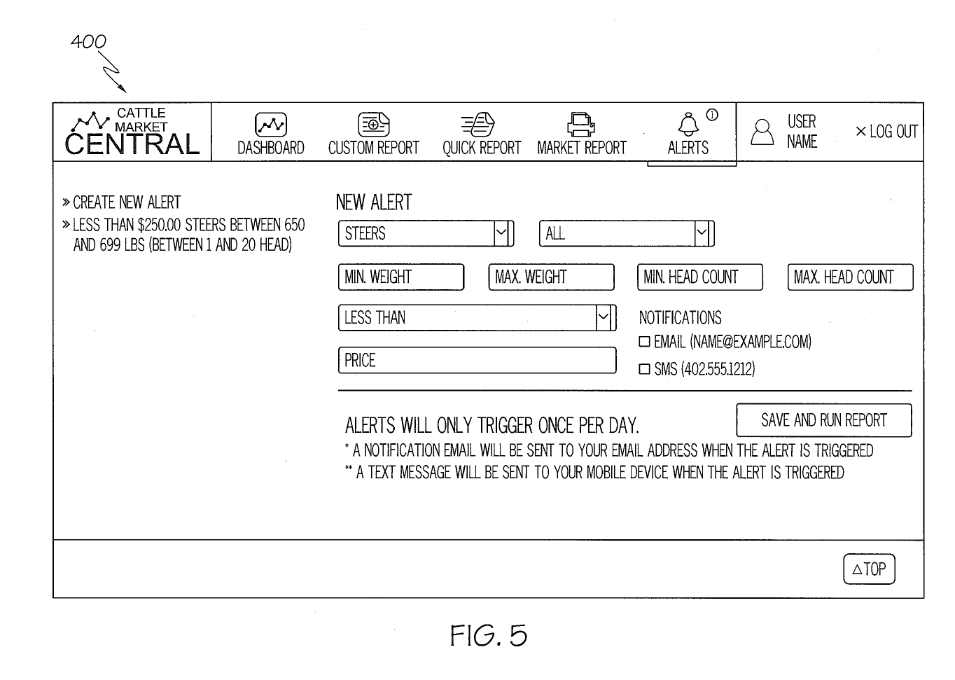

The method and system of the present invention may also include an alert module 228, which may be accessible through the platform 210. As shown in FIG. 1, the alert module 228 may have an alert module interface 400 that allows users to select or enter one or more specific parameter thresholds to be used in creating a customized alert. The alert module 228 may then search the information database 206 and generate an alert 402 when auction results data satisfying the parameter threshold requirement selected by the user is identified. The customized alert 402 identifying the auction results data satisfying the user-selected threshold, or thresholds, may then be sent to the user. As best shown in FIG. 2, a user may access the platform 210, and the alert module 228, by accessing the platforhi application server 208 through a user device 218, such as a computer, tablet, mobile phone, or other suitable device. From the home-page graphical interface of the platform 210, a user may select the alert module 228. The platform 210 may then display the alert module graphical interface 400 as shown in FIG. 5, according to one embodiment of the present invention. The user may then select to create a new alert 402 through the graphical interface 400, as shown in FIG. 5, according to one embodiment of the present invention.

The alert module 228 and interface 400 may allow a user to select from several different parameters to generate an alert. The possible parameters may include any type of information included in the auction results data. For example, as shown in FIG. 5, when the method and system of the present invention is used in connection with livestock according to one embodiment, the alert module 228 and interface 400 may allow a user to select from one or more of the following parameters: cattle category (e.g., steers, heifers, all, etc.), location (e.g., region, state, auction site, all, etc.), weight range (e.g., 600-699 lbs.), and head count range (e.g., 1-15). The alert module 228 and interface 400 may also allow the user to select a specific sale price threshold for generating the alert. In alternative embodiments where the method and system of the present invention are used in connection with other goods and services, the specific parameters included in the alert module 228 may be different from those shown in FIG. 5, including any information included in the auction results data and categorized in the information database 206.

Once the user creates the alert through the alert module 228 in the platform 210, the system 200, through the platform application server 208, may be directed to search the information database 206 for any auction results data satisfying the parameter threshold(s) selected by the user. As shown in FIG. 1, if the system 200 fails to identify any auction results data in the information database 206 that satisfies the user-selected parameter threshold, the system 200 may repeat the search of the information database 206. The searches under the alert module 228 may be performed at any number of intervals. In one embodiment, the system 200 searches the information database 206 immediately upon receiving alert parameters from a user. According to the same embodiment, if the system 200 fails to identify auction results data satisfying the parameter threshold(s), the system 200 directs the platform application server 208 to search the information database 206 every hour until auction results data satisfying the parameter threshold(s) is identified. In an alternative embodiment, the system 200 may direct the platform application server 208 to perform additional searches once per day. In yet another alternative embodiment, the system 200 directs additional searches of the information database 206 every time the information database 206 receives new or updated auction results data from the data collection server 202 and/or formatting application server 204.

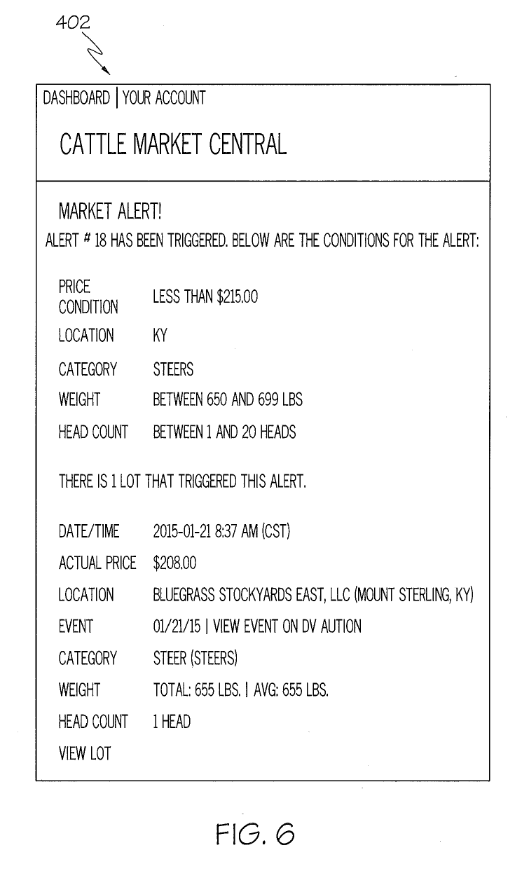

As shown in FIG. 1, if the system 200 identifies auction results data satisfying the user-selected parameter threshold(s), an alert 402 identifying the auction results data satisfying the threshold(s) may be generated and sent to the user. An alert generator 214 linked to the platform application server 208 may be provided within the system, as shown in FIG. 2. The platform application server 208 may direct the alert generator 214 to create an alert 402, as shown in FIG. 6, which may include the auction results data identified in the information database 206 that satisfied the user-selected parameter threshold(s). The system 200 may then send the generated alert 402 to the user through an alert message gateway, such as through email or text. The user may then receive the generated alert 402 on a user device 218, such as a computer, tablet, mobile phone, or other mobile device. As shown in FIG. 6, the alert 402 may display the parameter thresholds selected by the user when creating the alert. The alert 402 may also identify the number of lots/sales that triggered the alert 402. The alert 402 may also display the auction results data for one or more of the lots/sales that triggered the alert 402, as shown in FIG. 6. Additionally, the alert 402 may provide a link to the platform 210, where the user may be able to view additional auction results data related to the triggering lot/sale.

As set forth above, the method and system of the present invention may be applied to virtually any industry. With the combination of pre-defined lot information and sale-time data, such as pricing and buyer information, a multitude of reports and statistics can be generated in real time. Pre-defined lot information can include any field-value pair, so data related to any sale item can be assigned to the lot (e.g., make/model/year of a vehicle for auto auctions, hours/dimensions for equipment auctions, etc.). Once the lot has been sold, a purchase record can permanently be created in the database which associates the buyer's information with the lot's information. As soon as the purchase is created, real-time information can be generated which allows members to view geographical and pricing statistics.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for generating and displaying customizable reports comprising the steps of:
acquiring auction results data from at least one auction site;
formatting the auction results data;
storing the auction results data in at least one information database;
receiving one or more parameter criteria from a user;
searching the at least one information database;
identifying the auction results data stored in the at least one information database satisfying the parameter criteria;
generating a customized report displaying the auction results data satisfying the parameter criteria; and
displaying the customized report to the user.

2. The method of claim 1, wherein the auction results data is acquired from two or more auction sites.

3. The method of claim 1, wherein the customized report includes auction results data from at least two auction sites.

4. The method of claim 1, wherein the auction results data includes one or more data components concerning a sale of goods or services occurring at the at least one auction site.

5. The method of claim 4, wherein the auction results data displayed in the customized report includes a visual data component of the sale of goods or services.

6. A method for generating and displaying a customizable alert comprising the steps of:
acquiring auction results data from at least one auction site;
formatting the auction results data;
storing the auction results data in at least one information database;
receiving one or more parameter thresholds from a user;
searching the at least one information database at a specified time interval until auction results data stored in the at least one information database is identified as satisfying the one or more parameter thresholds;
generating a customized alert displaying the auction results data satisfying the one or more parameter thresholds; and
sending the customized alert to the user via at least one of and SMS text.

7. The method of claim 6, wherein the customized alert is sent to the user via at least one of email and SMS text.

8. The method of claim 6, wherein the auction results data is acquired from two or more auction sites.

9. The method of claim 6, wherein the auction results data includes one or more data components concerning a sale of goods or services occurring at the at least one auction site.

10. A computer-network system for aggregating and displaying auction results data, the system comprising:
a data collection server for collecting auction results data from one or more auction sites through an internet network;
a formatting application server for formatting the auction results data collected by the data collection server, wherein the formatting application server is in communication with the data collection server;
an information database for storing the auction results data formatted by the formatting application server, wherein the information database is in communication with the formatting application server;
a platform application server for communicating between the information database and an online platform interface, wherein the platform application server is in communication with the information database; and
a report generator for generating customized reports, the report generator being in communication with the platform application server;
wherein the online platform interface is adapted for displaying a custom report module that includes at least one input box where a user may input one or more parameter criteria.

11. The system of claim 10 further comprising an alert generator, the alert generator being in communication with the platform application server, and wherein the online platform interface is adapted for displaying a custom alert module that includes at least one input box where a user may input one or more parameter thresholds.

12. The system of claim 10, wherein the online platform interface may display the customized report to the user when the user is connected to the system through a user device.

13. The system of claim 11, wherein the alert generator is adapted for sending an alert to a user though an email or a text message.
